(19) United States
(12) Patent Application Publication
(10) Pub. No.: US 2013/0200318 A1
(43) Pub. Date: Aug. 8, 2013

(54) CABLE LIFTING APPARATUS

(71) Applicants: Juan Julián Asensio Bazterra, Lazkao (Gipuzkoa) (ES); Enrique Del Pozo Polidoro, Lazkao (Gipuzkoa) (ES)

(72) Inventors: Juan Julián Asensio Bazterra, Lazkao (Gipuzkoa) (ES); Enrique Del Pozo Polidoro, Lazkao (Gipuzkoa) (ES)

(73) Assignee: ELEVADORES GOIAN, S.L., Lazkao (Gipuzkoa) (ES)

(21) Appl. No.: 13/879,952

(22) PCT Filed: Oct. 20, 2011
(86) PCT No.: PCT/ES2011/070724

§ 371 Date: Apr. 17, 2013

(30) Foreign Application Priority Data
Oct. 21, 2010 (ES) U 201031046

(51) Int. Cl. B66D 1/26

(52) U.S. Cl. CPC B66D 1/26
USPC 254/295

(57) ABSTRACT

The invention relates to a cable-based lifting device intended to move loads using multiple cables (1) coupled to an equal number peripheral grooves (2) provided in a single driving pulley (3). The invention comprises: a power unit (6) formed by a motor, a brake, a centrifugal brake and gear reducer, all mounted on a supporting shaft (7); a housing (8) which can be secured to the load to be lifted and in which the aforementioned supporting shaft (7) is housed; a structure (9) which can pivot in relation to the shaft (7) and in relation to the housing (8), said structure containing a pinion coupled to the output of the gear reducer of the power unit (6) and meshed with a toothed wheel (10) that rotates integrally with and concentrically to the driving pulley (3) about the shaft (5); and rollers (11).

As indicated by its title, the present specification refers to a cable lifting apparatus as used to vertically lift or help in the ascent of people or loads, specifically being used for ascending long ladders, like those used in silos, cranes, towers, wind generators, etc., characterised in that they use two or more cables that pass through a multi-groove swivel pulley, formed by several coaxial plates with longitudinal displacement through the central bushing and with capacity for self-adjustment of the cables, associated with a series of independent pressure rollers for each cable, each of these roller sets being mounted in a casing that pivots over a laterally positioned axle.

Currently, multiple and varied types of apparatuses suitable for the lifting of loads and/or persons, either directly using a cable for lifting, or using the cable in conjunction with a stairway, in this case being used as an aid to ascent, are widely known. In the majority of known uses, it is common practice to pass a cable through a fixed axle pulley, and at one point on the pulley periphery to apply radial pressure to the cable by means of rollers that constantly press the cable against the pulley, thanks to a compressed spring, which exercises continuous pressure on the cable. Examples of these embodiments are described in patents ES 0553097 and US D 491333, and on the one hand they are inconvenient because they always apply the same pressure, regardless of the load to be lifted or borne, which in turn increases wear and reduces the useful life of the device, and on the other hand, safety problems may arise as a result of using only one cable, as this single cable has to bear all the weight to be lifted, for which reason great care must be taken with inspections and maintenance in order to keep the installation operational in opportune safety conditions.

Other devices are also known, like those claimed in the patent U.S. Pat. No. 5,090,666, where the radial pressure applied to the cable is dependent on the load to be lifted, slightly improving on the previous solutions, although with the safety problems inherent in the use of a single cable persisting.

Other solutions have been researched, like for example that described in the ES 2306088 Patent, a method to regulate the traction in one line of a device for assisting ascent by means of a ladder and a device to aid ascending by means of a ladder by using methods for movement detection of the line in the form of an encoder that generates pulses, then applying traction to the pulley by controlling the motor, although the safety problems inherent in the use of only one cable also persist.

There are some devices that permit the use of several cables to increase the lifting safety of persons and loads, like for example that described in Patent ES 2316300 Cable lifting apparatus, in which the pressure applied depends on the load by means of the tangential reaction of the activation pinion mounted on the output of the reducer, that with a support ring engages with the traction pulley, thanks to a swivelling box that contains the pinions and the activation pulley, combined with the load to be lifted and with a pulley throat angle with larger dimensions, although the inconvenience of this is that the pressure applied between the rollers and the traction pulley is constant, regardless of the load, due to the rollers being pressurised at a fixed rate by a spring. Likewise this device includes some grooves that can be adapted to the cables by means of some parallel plates linked to each other by elastic means, which has the added inconvenience of being a difficult mechanical solution that is costly to manufacture, in addition to propitiating an improvable performance.

To resolve the current problems regarding the cable lifting apparatus, improving the existing technology, the cable lifting apparatus forming the object of this invention has been designed and uses cables coupled to the same number of peripheral grooves of a single traction pulley.

The lifting device basically comprises a power plant housed in a casing where the axle on which a traction pulley support structure pivots is housed, including a pinion inside coupled to the output of the reducer in the power plant and geared with a supporting, conical toothed wheel as regards the rotation on the traction pulley axle.

The peripheral grooves of the traction pulley are formed by several independent adjacent plates, with bevelled peripheral edges that define the groove, provided with a slight lateral displacement by balance of forces through a retention bush located on the turning axle of the pulley, that way achieving an automatic regulation of the cable traction pulley.

Likewise, some pressure rollers used for applying adequate pressure to the cables when the pulley support structure pivots on its axle and that way obtaining the necessary adherence for lifting the load, are located inside the casing and on which each of the suspension cables is pressed by an independent series of rollers. Each of these independent series of rollers that presses the suspension cables against the peripheral grooves of the traction pulley is mounted on a swinging support plate, linked through a turning axle to another second plate that is linked to the casing by means of a second turning axle located at one end, and has a spring located between the previously mentioned second plate and the wall of the casing. There is an activator and electrical position detector unit at the opposite end of the second turning axle.

The cable lifting apparatus being described provides multiple advantages over those currently available, the most important of which is that, thanks to peripheral grooves of the traction pulley formed by multiple independent adjacent plates provided with lateral displacement by balancing of efforts, an automatic regulation of the cable traction pulley is achieved, that way obtaining an optimal contact with the grooves that redounds into better adherence to the cable, less jamming of the cable and less wear by friction of rubbing parts.

It is necessary to highlight that the use of a traction pulley with peripheral grooves formed by multiple independent adjacent plates provided with slight lateral displacement by balancing the efforts propitiates an efficient sharing of the loads that allows equalling of the tensions in branches of cables laid out in parallel, propitiating the better operation of the device.

Another important advantage is the fact that likewise each of the independent series of rollers, by being fixed to a swinging strip that pivots on an axle contributes to this improved operation, therefore allowing the friction caused by the load to be shared, that way achieving the application of less force when there is less load, contrary to the existing units that always supply a constant force, with the consequent inconvenience when used with less load.

Another advantage of this invention is that, as a consequence of the improved adherence to the cable caused by the automatically adapted pulley together with the sharing of the force achieved by the independent series of swinging pulleys, smooth displacement of the load is achieved with better usage of the motor torque.

We should likewise highlight that, as a consequence of that mentioned above, there is less wear of the parts under friction, which propitiates longer duration, and useful life of the device, fewer breakages and less need for maintenance.

It is important to highlight that when using several traction cables the safety and reliability of use are markedly increased in comparison to that of single cable devices.

Lastly we must emphasise that this invention can be employed for any vertical lifting device that uses two or more cables, such as climbers used to assist in the ascent of ladders, or lifts for persons or lifts for loads.

A preferred embodiment of a cable lifting device is shown in the attached drawing for a better understanding of the object of this invention.

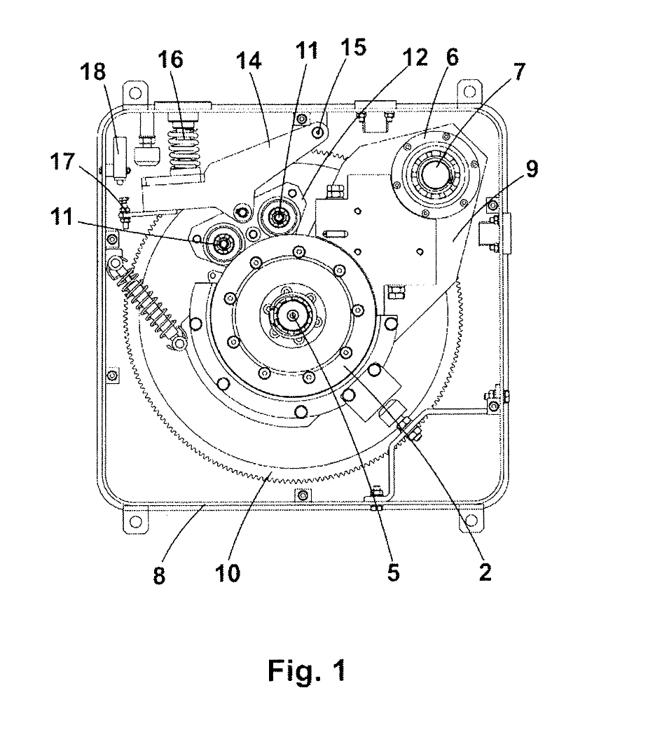

FIG. 1—of the aforementioned drawing shows a lateral view, with the casing open and with part of the support structure of the pulley removed for a better appreciation of the series of rollers.

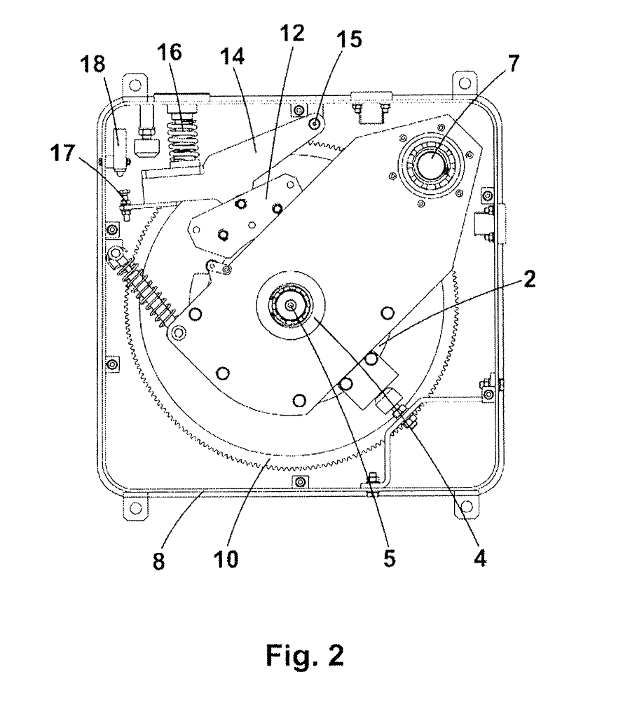

FIG. 2—shows a side view, with the casing open.

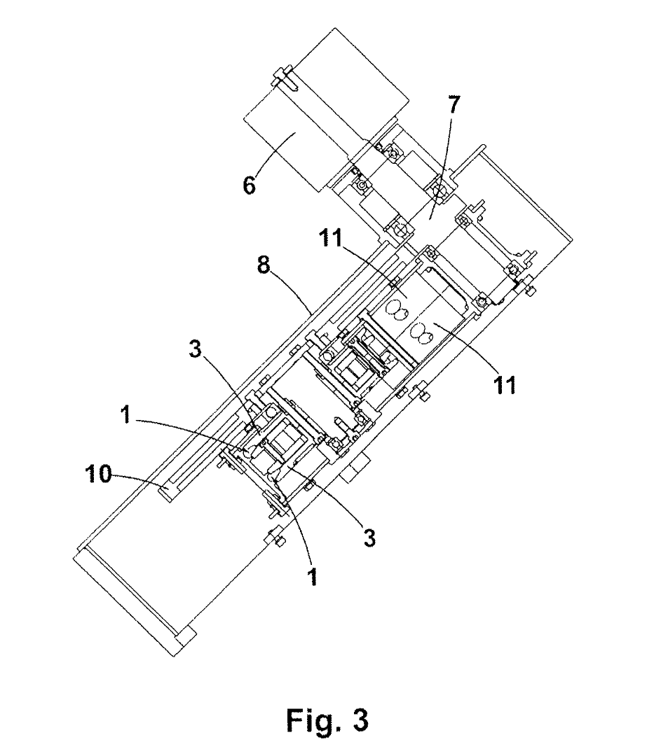

FIG. 3—shows a top plan view.

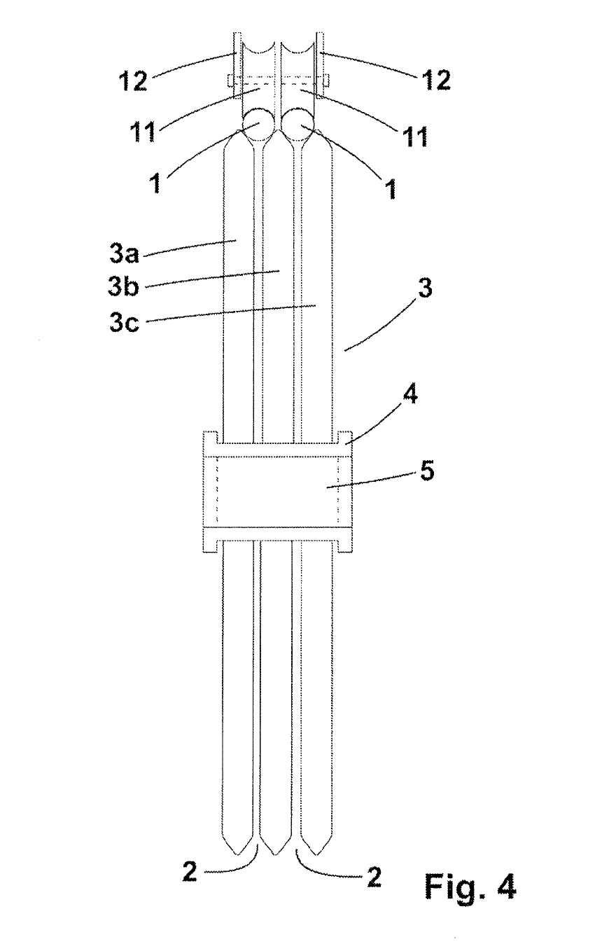

FIG. 4—shows a side elevation view of a detail of the disks that form the pulley, the cables and the series of rollers.

The cable lifting apparatus forming the object of this invention allows loads to be moved using several cables (1) coupled to an equal number of peripheral grooves (2) of only one traction pulley (3) and this basically comprises, as can be seen in the attached drawing, a power plant (6) formed by a motor, brake, centrifugal brake and reducer mounted on a support axle (7), located in a casing (8) which can be fixed to the load to be lifted, and on which the mentioned support axle (7) is housed, over which the support structure (9) for the traction pulley (3) pivots and inside includes a pinion coupled to the output of the reducer in the power plant (6) and geared with a supporting toothed wheel (10), and concentric regarding the rotation on the axle (5) with the traction pulley (3). Inside the casing (8) there are likewise located some pressure rollers (11) that apply adequate pressure to the cables (1) when the structure (9) pivots on the mentioned axle (7) and where each of the suspension cables (1) is pressed by an independent series of rollers (11).

The peripheral grooves (2) of the traction pulley (3) are defined by several independent adjacent pulleys (3a, 3b, 3c), with bevelled peripheral edges, in an equal number of grooves (2) plus one, provided with lateral displacement by balancing of forces through a retention bush (4) located on a turning axle (5), that way achieving automatic regulation of the traction pulley (3) to the cables (1) with optimal contact with the grooves (2), redounding in improved adherence, in smoother displacement and with better usage of the motor torque.

Likewise, each of the independent series of rollers (11) that press the suspension cables (1) against the peripheral grooves (2) of the traction pulley (3), that are mounted on a swinging support plate (12), linked through a turning axle (13) with another second plate (14) or arm that, on one end is linked to the casing (8) by means of a second turning axle (15), as well having an elastic element (16), preferably a spring, located between the afore-mentioned second plate (14) and the wall of the casing (8), contribute to this improved operation.

The second plate (14) likewise has at the opposite end to that of the second turning axle (15) mechanical means (17) of activating an electrical position detector (18) located on the wall of the casing (8).

In a preferred embodiment of the invention, the cable lifting apparatus uses two suspension cables (1), therefore likewise having two traction pulley (3) grooves (2) and two series of rollers (11) while there are three independent adjacent plates (3a, 3b, 3c).

This invention can be employed in any vertical elevation device that uses two or more cables, such as climbers for assisting the ascent of ladders, or lifts for people or lifts for loads.

1. Cable lifting apparatus for moving loads with the use of several cables (1) coupled to an equal number of peripheral grooves (2) of a single traction pulley (3), and consisting of a power plant (6) formed by a motor, brake, centrifugal brake and reducer on a support axle (7), a housing (8) which can be fixed to the load to be lifted, and where the mentioned support axle (7) is housed, a pivoting structure (9) in regard to the axle (7), capable of pivoting in regard to the aforementioned housing (8) and that includes inside a pinion coupled to the output of the reducer of the power plant (6) and geared to a supporting toothed wheel (10), concentric in regard to a rotation on the axle (5) with the traction pulley (3), and likewise consisting of some pressure rollers (11) used for applying adequate pressure to the mentioned cables (1) when the structure (9) pivots on the mentioned axle (7) and on which each of the suspension cables (1) is pressed by a independent series of rollers (11), characterised in that the peripheral grooves (2) of the traction pulley (3) are defined by several independent adjacent plates (3a, 3b, 3c) with bevelled peripheral edges, in equal number to the grooves (2) plus one, provided with lateral displacement by balancing forces through a bushing (4) located on the turning axle (5), and in that each of the independent roller units (11) that press the suspension cables (1) against the peripheral grooves (2) of the traction pulley (3) are mounted on a swinging support plate (12), linked through a turning axle (13) to another second plate (14), or arm that at one end is linked to the casing (8) by means of a second turning axle (15), as well as having an elastic element (16) located between the afore-mentioned second plate (14) and the wall of the casing (8).

2. Cable lifting apparatus, according to claim 1, characterised in that the second plate (14) has, at the opposite end to that of the second axle (15), some mechanical means (17) for activating an electrical position detector (18) located on the wall of the casing (8).

3. Cable lifting apparatus, according to claim 1, characterised in that the elastic element (16) is a spring.

4. Cable lifting apparatus, according to claim 1, characterised in that there are two suspension cables (1), and therefore there are likewise two traction pulley (3) grooves (2) and two roller units (11) and there are three independent adjacent plates (3a, 3b, 3c).
